(19) United States
(12) Patent Application Publication
(10) Pub. No.: US 2006/0202176 A1
(43) Pub. Date: Sep. 14, 2006

(54) Flame-retardant fabric and method for manufacturing the same

(75) Inventors: Ai Koyama, Okazaki-shi (JP); Toshiyuki Kobayashi, Toyota-shi (JP); Masahisa Kitano, Osaka (JP); Keiichi Maenami, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SUMINOE TEXTILE CO., LTD., Osaka-shi (JP); TOYOTA JIDOSHA KABUSHIKI KAISHA, Toyota-shi (JP)

(21) Appl. No.: 11/358,708

(22) Filed: Feb. 22, 2006

(30) Foreign Application Priority Data
Feb. 23, 2005 (JP) 2005-46563

(51) Int. Cl. C09K 21/00

(52) U.S. Cl. 252/608

(57) ABSTRACT

A flame-retardant fabric 1 of the present invention comprises: a fiber fabric 4; and a back layer 5 formed on the back surface of the fiber fabric 4 and containing at least one of inorganic compound selected from the group consisting of calcium carbonate and magnesium hydroxide, thermally expansive graphite and a polymer substance. The adhering amount of solid of the back layer 5 is 50 to 150 g/m². The adhering amount of the thermally expansive graphite is 15 to 60 g/m². The adhering amount of the inorganic compound is 10 to 60 g/m². The flame-retardant fabric causes no generation of noxious substances in case of fire and at incineration disposal, can impart sufficient initial flame retardancy, and has excellent flame-retardant performance in heat aging.

This application claims priority to Japanese Patent Application No. 2005-46563 filed on Feb. 23, 2005, the entire disclosure of which is incorporated herein by reference in its entirety.

### BACKGROUND OF THE INVENTION

1. Field of the Invention

The present invention relates to a flame-retardant fabric suitably used as a vehicular interior material such as, for example, an automobile surface sheet material and an automobile floor mat.

2. Description of the Related Art

The following description sets forth the inventor's knowledge of related art and problems therein and should not be construed as an admission of knowledge in the prior art.

The provision of excellent flame retardancy is required for the vehicular interior material such as the automobile surface sheet material and the automobile floor mat in order to enhance safety in case of fire. In order to satisfy the requirement of the flame retardancy, a flame-retardant has been conventionally contained in a back layer provided on a back surface of the vehicle floor mat and made of a synthetic resin. As the flame-retardant, for example, many flame-retardants (halogen flame-retardant) having a chemical structure having halogen such as a chlorine atom and a bromine atom have been used (for example, see patent document 1).

However, it has been known that the halogen flame-retardant generates noxious substances such as hydrogen chloride gas and halogen gas in case of fire, and it was not preferable in view of the safe reservation of a passenger. It has been pointed out that various noxious substances are generated at incineration disposal after use, and it has been not preferable in view of earth environment protection.

It has been proposed to contain thermally expansive graphite as the flame-retardant in a water-based synthetic resin emulsion forming the back layer (see patent document 2). The technique can impart sufficient flame retardancy, and no noxious substance is generated in case of fire and at incineration disposal.

When the thermally expansive graphite is contained as the flame-retardant in the emulsion, ammonium polyphosphate has been often combined and contained as a flame resisting auxiliary agent in order to further enhance the flame-retardant effect (see patent document 3).

Patent Document 1: Japanese Unexamined Laid-open Patent Publication No. No. 6-166148 (Claim 1, paragraph 0019)

Patent Document 2: Japanese Unexamined Laid-open Patent Publication No. 2001-73275 (Claim 1, paragraph 0015)

Patent Document 3: WO2004-033585 pamphlet (page 10, lines 23 to 24, page 15, Table 1)

Though the structure (flame-retardant fabric) where the ammonium polyphosphate is combined as the flame resisting auxiliary agent can secure the initial flame-retardant performance sufficiently, the structure had a problem that the flame-retardant performance in heat aging (after the load of the long-term heat history) of the flame-retardant fabric is reduced. For example, since a vehicle interior temperature is fairly high in an automobile, particularly in summer, it is very important as products to excel in the flame-retardant performance in heat aging in the use of the vehicular interior material such as the automobile surface sheet material and the automobile floor mat, and therefore, the sufficient enhancement of the flame-retardant performance in heat aging has been strongly required.

The present invention has been accomplished base on the technical background, and it is an object of the present invention to a flame-retardant fabric capable of imparting sufficient initial flame retardancy without generating noxious substances in case of fire and at incineration disposal and having excellent flame-retardant performance in heat aging.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

[1] A flame-retardant fabric comprising:

a fiber fabric; and

a back layer formed on a back surface of the fiber fabric and containing at least one of inorganic compound selected from the group consisting of calcium carbonate and magnesium hydroxide, thermally expansive graphite and a polymer substance,

wherein an adhering amount of solid of the back layer is 50 to 150 g/m²;

an adhering amount of the thermally expansive graphite is 15 to 60 g/m²; and

an adhering amount of the inorganic compound is 10 to 60 g/m².

[2] The flame-retardant fabric as recited in the aforementioned Item [1], wherein at least a part of a surface of the thermally expansive graphite is coated by a phosphate ester and a surface-active agent.

[3] The flame-retardant fabric as recited in the aforementioned Item [1], wherein at least a part of a surface of the thermally expansive graphite is coated by a surface-active agent layer intervening a phosphate ester layer.

[4] The flame-retardant fabric as recited in any one of the aforementioned Items [1] to [3], wherein the adhering amount of the thermally expansive graphite/the adhering amount of the inorganic compound is within the range of 0.3 to 3.

[5] The flame-retardant fabric as recited in any one of the aforementioned Items [1] to [4], wherein the back layer has a foaming structure, and a foaming ratio is 1.1 to 15 times.

[6] The flame-retardant fabric as recited in any one of the aforementioned Items [1] to [5], wherein the flame-retardant fabric is used as a vehicular interior material.

[7] A method for manufacturing a flame-retardant fabric, comprising a step of applying a water-based polymer emulsion onto a back surface of a fiber fabric and drying it, wherein the water-based polymer emulsion contains 80 to 200 parts by mass of a filler component based on 100 parts by mass of a polymer substance, and the filler component comprises at least one of inorganic compound selected from the group consisting of calcium carbonate and magnesium hydroxide, and thermally expansive graphite,

a ratio of a content of the thermally expansive graphite/a content of the inorganic compound is set to be 0.3 to 3, and

an amount of applied solid is set to be within a range of 50 to 150 g/m².

Since the back layer contains the thermally expansive graphite of amount in the specific range in the invention according to the item [1], the invention can impart sufficient flame retardancy. In addition, since the invention uses no halogen flame-retardant, no noxious substance is also generated in case of fire and at incineration disposal. Furthermore, since the back layer also contains the specific inorganic compound (at least one kind of inorganic compound selected from the group consisting of calcium carbonate and magnesium hydroxide) of the amount in the specific range, the back layer also has excellent flame-retardant performance in heat aging. That is, even after receiving a long-term heat history, sufficient flame retardancy can be maintained. Therefore, the flame-retardant fabric of the present invention is particularly suitable as the vehicular interior material such as the automobile surface sheet material and automobile floor mat frequently exposed under high-temperature conditions.

Since at least a part of the surface of the thermally expansive graphite is coated by the surface-active agent in the invention according to the items [2], [3], the thermally expansive graphite has excellent dispersing stability, and for example, the thermally expansive graphite is not condensed, settled and separated in a water-based synthetic resin emulsion. Therefore, when the emulsion or the like is applied onto the back surface of the fiber fabric, the thermally expansive graphite is imparted to the fiber fabric in a homogeneous dispersion state. Since the phosphate ester is also coated on at least a part of the surface of the thermally expansive graphite, the fixing stability of the surface-active agent can be improved.

Since at least a part of the surface of the thermally expansive graphite is coated by the surface-active agent layer intervening the phosphate ester layer in the invention according to the item [3], the separation of the surface-active agent can be effectively prevented, and thereby the thermally expansive graphite is imparted to the fiber fabric in the sufficient homogeneous dispersion state.

Since the adhering amount of the thermally expansive graphite/the adhering amount of the inorganic compound is set to the range of 0.5 to 2 in the invention according to the item [4], the flame-retardant performance in heat aging can be further improved.

Since the back layer has the foaming structure in the invention according to the item [5], the back layer has an advantage that the expansion of the thermally expansive graphite is hardly impeded. Since the foaming ratio of the back layer is 1.1 to 15 times, the flame-retardant fabric can be made lighter in weight, and sufficient flexibility can be imparted to the fabric.

Since the flame-retardant fabric is used as the vehicular interior material in the invention according to [6], the fire resistance in the vehicle can be improved.

Since the formed back layer contains the thermally expansive graphite of amount in the specific range in the invention according to the item [7], the invention can impart sufficient flame retardancy. In addition, since the halogen flame-retardant is not used, no noxious substance is also generated in case of fire and at incineration disposal. Furthermore, since the back layer also contains the specific inorganic compound (at least one kind of inorganic compound selected from the group consisting of calcium carbonate and magnesium hydroxide) of the amount in the specific range, the back layer also has excellent flame-retardant performance in heat aging. That is, even after receiving a long-term heat history, sufficient flame retardancy can be maintained. Therefore, the flame-retardant fabric can be manufactured, which is particularly suitable as the vehicular interior material such as the automobile surface sheet material and automobile floor mat frequently exposed under high-temperature conditions.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a sectional view showing a flame-retardant fabric according to an embodiment of the present invention.

### DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, a flame-retardant fabric according to an embodiment of the present invention will be explained with reference to drawings.

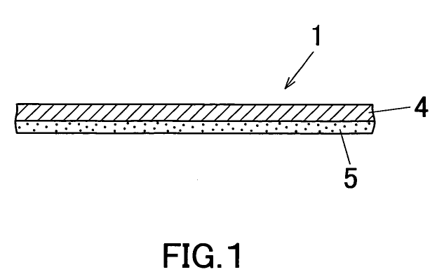

FIG. 1 shows an embodiment of a flame-retardant fabric 1 according to the present invention. The flame-retardant fabric 1 is obtained by integrally laminating a back layer 5 on a back surface of a fiber fabric 4 composed by a plain woven fabric.

For example, The back layer 5 is formed by applying and drying a water-based synthetic resin emulsion containing at least one of inorganic compound selected from the group consisting of calcium carbonate and magnesium hydroxide, thermally expansive graphite and a polymer substance onto the back surface of the fiber fabric 4.

In the present invention, the adhering amount of solid of the back layer 5 is set to the range of 50 to 150 g/m². When the adhering amount is less than 50 g/m², a carbonized layer due to the thermally expansive graphite is not sufficiently obtained, and it becomes difficult to maintain the flame retardancy. On the other hand, when the adhering amount exceeds 150 g/m², it becomes difficult to maintain the lightness, and the flexibility of the flame-retardant fabric 1 is reduced. Among them, it is preferable that the adhering amount of solid of the back layer 5 is set to the range of 70 to 100 g/m². Examples of the solids include the specific inorganic compound (at least one of inorganic compound selected from the group consisting of calcium carbonate and magnesium hydroxide), the thermally expansive graphite and the polymer substance.

The adhering amount of the thermally expansive graphite is set to the range of 15 to 60 g/m². When the adhering amount is less than 15 g/m², sufficient flame-retardant performance is not obtained. When the adhering amount exceeds 60 g/m², surface hue is slightly thickened, and dirt is generated in rolling up. Among them, it is preferable that the adhering amount of the thermally expansive graphite is set to the range of 20 to 40 g/m². When composite thermally expansive graphite (first composite thermally expansive graphite or second composite thermally expansive graphite) to be described later is used as the thermally expansive graphite, the adhering amount of the composite thermally expansive graphite (the adhering amount as the whole of one obtained by compounding the thermally expansive graphite, the phosphate ester and the surface-active agent) is set to the range of 15 to 50 g/m².

The adhering amount of the specific inorganic compound (at least one of inorganic compound selected from the group consisting of calcium carbonate and magnesium hydroxide) is set to the range of 10 to 60 g/m². When the adhering amount is less than 10 g/m², the flame-retardant performance in heat aging is reduced. When the adhering amount exceeds 60 g/m², the aesthetic property of the fabric is impaired. Among them, it is preferable that the adhering amount of the specific inorganic compound is set to the range of 15 to 40 g/m².

Herein, the reason of the selection of the specific inorganic compound (calcium carbonate and/or magnesium hydroxide) in the present invention will be described. Since the inorganic compound itself is not generally burned, the flame retardancy can be imparted by kneading the inorganic compound to the resin or the like. It has been conventionally considered that aluminium hydroxide or the like having large endoergic amount at the thermal decomposition and decomposed at about the material temperature (generally 400 to 600° C.) at burning is preferable. On the other hand, since the present invention uses the thermally expansive graphite, it is important to sufficiently secure the thermal expansion of the thermally expansive graphite. As a typical example, the thermally expansive graphite starts the expansion at the temperature exceeding 200° C. The expansion of about 50% is obtained near 500° C., and the expansion of 80 to 90% is obtained near 700° C. When an inorganic compound having low decomposition temperature such as aluminium hydroxide (decomposition temperature: 250° C.) is kneaded in large quantity in the composition using the thermally expansive graphite, the material temperature at burning is reduced by the endothermic action at the decomposition of the inorganic compound, and as a result, the thermally expansive graphite cannot be sufficiently expanded. Consequentially, in the present invention, the calcium carbonate and/or the magnesium hydroxide are selected in the composition using the thermally expansive graphite. As a typical example, since the calcium carbonate has high decomposition temperature of about 850° C. and large endoergic amount of about 1800 J/g, the calcium carbonate is not decomposed up to about 850° C. (the material temperature at burning is not reduced by the endothermic action). Thereby, the expansion of the thermally expansive graphite is not inhibited. The thermally expansive graphite is effectively expanded at a portion where origin of fire contacts with the material, and thereby air is blockaded. At the same time, the calcium carbonate itself is decomposed, and sufficient endothermic action is exhibited, thereby obtaining high flame-retardant effect by the synergistic effect thereof. As a typical example, since the magnesium hydroxide has comparatively high decomposition temperature of about 350° C. and large endoergic amount of about 1600 J/g, the expansion of thermally expansive graphite is inhibited, and the thermally expansive graphite expands effectively at a portion where which origin of fire contacts with the material, and thereby air is blockaded. At the same time, the magnesium hydroxide itself is decomposed, and a sufficient endothermic action is exhibited, thereby obtaining high flame-retardant effect by the synergistic effect thereof.

It is preferable that the adhering amount (g/m²) of the thermally expansive graphite/the adhering amount (g/m²) of the inorganic compound is the range of 0.3 to 3 in the back layer 5. It is not preferable that the flame-retardant performance tends to be reduced when the ratio is less than 0.3 and the flame-retardant performance tends to be reduced in heat aging when the ratio exceeds 3. Among them, it is particularly preferable that the adhering amount (g/m²) of the thermally expansive graphite/the adhering amount (g/m²) of the inorganic compound is the range of 0.5 to 2.

Though the back layer 5 may have any structure of a non-forming structure or foaming structure, it is preferable that the back layer 5 has the foaming structure. The foaming structure can cause the improved weight saving, and can impart sufficient flexibility to the flame-retardant fabric 1. It is preferable that the foaming ratio is 1.1 to 15 times when the foaming structure is adopted. When the foaming ratio is less than 1.1 times, it is not preferable that the sufficient weight saving is difficult, and the sufficient flexibility cannot be imparted to the fabric 1. It is not preferable that the stability of the foaming layer is reduced when the foaming ratio exceeds 15 times. Among these, the foaming ratio of the back layer 5 is more preferably 1.5 to 10 times, and particularly preferably 2 to 4 times.

Though the polymer substance constituting the back layer 5 is not particularly limited, a resin and a rubber are suitably used. Examples of the resins include resins such as an acrylic resin, a urethane resin, polyvinyl chloride, polyethylene, polypropylene and an ethylene-vinyl acetate copolymer (EVA). Examples of the rubbers include SBR (styrene-butadiene rubber), MBR (methylmethacrylate-butadiene rubber), NBR (acrylonitrile butadiene rubber) or a crude rubber. Of these, the acrylic resin is preferably used with a view to enabling the improvement of the adhesion stability.

The calcium carbonate (CaCO₃) is not particularly limited, and may be, for example, an anhydride and a hydrate. The average particle diameter of the calcium carbonate is preferably 1 to 50 μm. The magnesium hydroxide is not particularly limited, and may be, for example, an anhydride and a hydrate. The average particle diameter of the magnesium hydroxide is preferably 1 to 50 μm.

For example, though the thermally expansive graphite can be manufactured by reacting the powder and particles of natural graphite with sulfuric acid and an oxidizer and by subjecting the resultant mixture to acid removal, washing (neutralizing) and drying, the thermally expansive graphite is not particularly limited to one manufactured by such a manufacturing method. The method for manufacturing the thermally expansive graphite is also disclosed in, for example, Japanese Examined Patent Publication No. 60-34492. It has been generally known that when the thermally expansive graphite is heated at several hundred to about 1000° C., the distance between the layers is expanded from several dozen times to several hundred times.

It is preferable that at least a part of the surface of the thermally expansive graphite is coated by the phosphate ester and the surface-active agent (the first composite thermally expansive graphite), or at least a part of the surface of the thermally expansive graphite is coated by the surface-active agent layer intervening the phosphate ester layer (the second composite thermally expansive graphite). Since the surface-active agent is fixed to at least a part of surface of the thermally expansive graphite in the first composite thermally expansive graphite and the second composite thermally expansive graphite, the thermally expansive graphite has excellent dispersing stability. For example, the thermally expansive graphite is not condensed, settled and separated in the water-based synthetic resin emulsion, and therefore, when the emulsion is applied onto the back surface of the fiber fabric, the thermally expansive graphite is imparted to the fiber fabric in the homogeneous dispersion state. Furthermore, since at least a part of the surface of the thermally expansive graphite is coated by the surface-active agent layer intervening the phosphate ester layer in the second composite thermally expansive graphite, the separation of the surface-active agent can be effectively prevented, and thereby the thermally expansive graphite is imparted to the fiber fabric in the sufficient homogeneous dispersion state.

Though it is adequate to coat the phosphate ester and the surface-active agent on at least a part of the surface of the thermally expansive graphite in the composite thermally expansive graphite, the phosphate ester and the surface-active agent may be coated not only on the surface but also in the interlayer of the thermally expansive graphite.

The average particle diameter (normal temperature state) of the thermally expansive graphite is preferably 50 to 1000 μm. It is not preferable that sufficient flame-retardant performance is not obtained when the average particle diameter is less than 50 μm. It is not preferable that the dispersing stability is reduced when the average particle diameter exceeds 1000 μm and the thermally expansive graphite is easily dropped out from the fiber fabric. Among them, the average particle diameter (normal temperature state) of the thermally expansive graphite is more preferably 80 to 500 μm, and particularly preferably 120 to 330 μm.

It is preferable that the coating amount of the phosphate ester is 5 to 50 parts by weight based on the thermally expansive graphite of 100 parts by weight in the composite thermally expansive graphite and the coating amount of the surface-active agent is 0.5 to 10 parts by weight. It is not preferable that the fixing stability of the surface-active agent is reduced when the coating amount of the phosphate ester is less than the lower limit. On the other hand, it is not preferable that the increase of the effect cannot be expected even if the coating amount exceeds the upper limit, and the amount used is unnecessarily increased. It is not preferable that the dispersing stability tends to be reduced when the coating amount of the surface-active agent is less than the lower limit. On the other hand, it is not preferable that a windowpane tends to be clouded when the coating amount exceeds the upper limit. Among them, it is particularly preferable that the coating amount of the phosphate ester is 5 to 30 parts by weight and the coating amount of the surface-active agent is 0.5 to 5 parts by weight based on the thermally expansive graphite of 100 parts by weight.

The phosphate ester is not particularly limited, and the phosphate ester having a molecular weight of 400 to 1500 is preferably used. It is not preferable that the volatility and the sublimating property are increased when the molecular weight is less than 400, and thereby clouding is easily generated on the windowpane or the like. It is not preferable that the solubility to a solvent and the dispersing stability in the solvent are reduced when the molecular weight exceeds 1500. Among them, it is particularly preferable to use the phosphate ester having a molecular weight of 500 to 1000.

Though the phosphate ester having a molecular weight of 400 to 1500 is not particularly limited, examples thereof include resorcinol bis-diphenylphosphate, bisphenol A bis-diphenylphosphate, aromatic condensed phosphate ester, isopropyltriphenylphosphate ester, butyltriphenylphosphate ester and polyaryl phosphate.

It is preferable to use the phosphate ester having a viscosity of 500 to 800 mPa·s (25° C.).

Though the surface-active agent is not particularly limited, examples thereof include a cationic surface-active agent, an anionic surface-active agent, an ampholytic surface-active agent and a nonionic surface-active agent. Of these, the anionic surface-active agent is preferably used. In this case, the fixing tendency of the surface-active agent to thermally expansive graphite can be improved, and the separation of the surface-active agent can be surely prevented.

Though the anionic surface-active agent is not particularly preferably limited, it is preferable to use the anionic surface-active agent of one kind or two kinds or more selected from the group consisting of alkylbenzenesulfonate, alkylnaphthalenesulfonate, polyoxyethylenealkylethersulfate, secondary higher alcohol ethoxysulfate, polyoxyethyleneallylphenylethersulfate, polyoxyethylenealkylphenyl ethersulfate, polyoxyethylenealkyletherphosphate and polyoxyethylenealkylphenylether phosphate. When these specific compounds are used, the fixing tendency of the surface-active agent to the thermally expansive graphite can be further improved.

The first composite thermally expansive graphite can be manufactured by applying the organic solvent containing, for example, the phosphate ester and surface-active agent dissolved onto the thermally expansive graphite and drying the organic solvent.

An example of the method for manufacturing the second composite thermally expansive graphite will be described. First, the organic solvent containing the phosphate ester dissolved is applied onto the thermally expansive graphite (first application step). At this time, it is preferable to apply the thermally expansive graphite while stirring, and thereby, the phosphate ester can be fixed in more homogeneous state to the thermally expansive graphite. For example, the thermally expansive graphite stirred is applied from above while the thermally expansive graphite stirred in a mixer. It is preferable to apply the thermally expansive graphite by a spray method, and thereby, the phosphate ester can be fixed in more homogeneous state to the thermally expansive graphite.

The organic solvent is not particularly limited, and examples thereof include methanol, ethanol, acetone and methyl ethyl ketone. Among them, it is preferable to use the methanol. The use of the methanol can shorten the dry time.

A solvent containing the surface-active agent dissolved is applied to the thermally expansive graphite after the first application step (second application step). At this time, it is preferable to apply the thermally expansive graphite while stirring, and thereby, the surface-active agent can be fixed in more homogeneous state to the thermally expansive graphite. For example, the thermally expansive graphite is applied from above while the thermally expansive graphite stirred in the mixer. It is preferable to apply the thermally expansive graphite by the spray method, and thereby, the surface-active agent can be fixed in more homogeneous state to the thermally expansive graphite. The solvent is not particularly limited, and examples thereof include water, methanol, ethanol, acetone and methyl ethyl ketone. Among them, it is preferable to use the methanol. The use of the methanol can shorten the dry time.

The organic solvent in the first application step and the solvent or the like in the second application step are then evaporated by performing a dry process, thereby obtaining the second composite thermally expansive graphite of a dry state. The phosphate ester and the surface-active agent can be strongly fixed to the thermally expansive graphite by performing the dry process.

Though the dry step is not provided between the first application step and the second application step in the above manufacturing method, the dry step may be provided therebetween. Though the application is performed by the spray method in the above manufacturing method, the application may be performed by the other method, and for example, may be performed by a dipping method.

In the present invention, anything can be used as the fiber fabric 4. For example, though a plain woven fabric is used as the fiber fabric 4 in the above embodiment, the fabric of the other form may be used or knitted fabric may be used. A nonwoven fabric may be used as the fiber fabric 4, and a carpet base material may be used, which has a surface having a pile layer.

For example, a nonwoven fabric or the like obtained by mechanically bonding various kinds of fabrics and threads by needling or the like, or by chemically bonding by adhesives or the like can be used as the fiber fabric 4 in addition to a fabric obtained by knitting thread consisting of a synthetic fiber such as a polyester fiber, a nylon fiber, a polypropylene fiber and an acrylic fiber, or a natural fiber such as hemp, cotton and wool.

A pile material of the pile layer is not particularly limited when adopting the structure having the pile layer, and one or the like consisting of a fabric such as a polyester fiber, a nylon fiber, a polypropylene fiber, an acrylic fiber and a rayon fiber can be preferably used. In addition, one or the like consisting of a natural fiber such as hemp, cotton and wool can be used. The formation means of a pile layer is not particularly limited, and examples thereof include a means for forming a pile layer by warp woven pile weaving and weft pile weaving like, for example, moquette or the like, a means for forming the pile layer by implanting pile thread by a tufting machine or the like, a means for forming the pile layer by a knitting machine, and a means for bonding pile thread using adhesives to form the pile layer. The pile form is not particularly limited, and may be a cut pile and a loop pile or the like.

Next, an example of the method for manufacturing the flame-retardant fabric 1 according to the present invention will be described. For example, the flame-retardant fabric 1 of the present invention is obtained by applying and drying the water-based polymer emulsion containing at least one of inorganic compound selected from the group consisting of the calcium carbonate and the magnesium hydroxide, the thermally expansive graphite and the polymer substance onto the back surface of the fiber fabric 4.

It is preferable to use the first composite thermally expansive graphite or second composite thermally expansive graphite described above as the thermally expansive graphite.

It is preferable that the blending mass ratio of filler (thermally expansive graphite and the specific inorganic compound) to the polymer substance in the water-based polymer emulsion is set to the range of 80 to 200 parts by mass based on the polymer substance of 100 parts by mass. It is preferable that the thermally expansive graphite/the specific inorganic compound is set to the range of 0.3 to 3 referring to the composition mass ratio in the filler. Thus, the water-based polymer emulsion is applied and dried on the back surface of the fiber fabric 4 so that the solid content application amount is 50 to 150 g/m².

The method for applying the emulsion to the back surface of the fiber fabric 4 is not particularly limited, and examples thereof include a doctor knife method, a roll coat method, a padding method and a spray method.

The water-based emulsion may contain various additives such as an antioxidant, an ultraviolet absorbent, a stabilizer, a pigment and a dye if needed other than water, a polymer substance, thermally expansive graphite, and a specific inorganic compound (calcium carbonate and/or magnesium hydroxide). The water-based emulsion may contain magnesium hydroxide and calcium hydroxide with calcium carbonate and/or magnesium hydroxide within a range not inhibiting the effect of the present invention.

In the present invention, the structure of the flame-retardant fabric 1 is not particularly limited to one illustrated in FIG. 1.

Next, specific examples of the present invention will be described.

### EXAMPLE 1

A methanol solution in which “PHOSCON 903N CONQ A” (trade name, manufactured by Meisei Chemical Works, Ltd., aromatic condensed phosphate ester, molecular weight: 512, viscosity: 650 mPa·s at 25° C.) of 50% by weight was dissolved and contained was spray applied onto thermally expansive graphite (average particle diameter: 300 μm, manufactured by Air Water Chemical Inc. stirred in a mixer from above. The thermally expansive graphite was then sufficiently stirred and mixed in the mixer. A methanol solution in which “PHOSCON 903N CONQ B” (trade name, manufactured by Meisei Chemical Works, Ltd., polyoxyethyleneallylphenylethersulfate as the anionic surface-active agent) of 50% by weight is dissolved and contained was spray applied onto the thermally expansive graphite stirred from above. The thermally expansive graphite was then sufficiently stirred and mixed in the mixer. The dry process was then performed at 100 to 120° C., and a flame-retardant was obtained. The flame-retardant was obtained by coating the phosphate ester of 6.7 parts by weight based on the thermally expansive graphite of 100 parts by weight, and coating the surface-active agent of 1.4 parts by weight.

Next, a water-based acrylic resin emulsion consisting of water of 80 parts by mass, a acrylic resin of 40 parts by mass, the flame-retardant of 20 parts by mass and calcium carbonate of 20 parts by mass was prepared. The emulsion of the applying amount (solid content) of 80 g/m² was applied onto the back surface of an automobile surface sheet material (fiber fabric) 4 by a doctor knife method. The dry process was then performed at 150° C., and the flame-retardant fabric was obtained. The automobile surface sheet material (fiber fabric) 4 consists of a plain woven fabric.

### EXAMPLES 2 TO 13, COMPARATIVE EXAMPLES 1 TO 8

Flame-retardant fabrics were obtained in the same manner as in Example 1 except that the emulsions consisting of the structures (composition, blending amount or the like) shown in Tables 1 to 3 were applied on the conditions shown in Tables.

The flame-retardant fabrics obtained as described above were variously evaluated based on the following evaluation method. Tables 1 to 3 show these results.

<Flame Retardancy Evaluation Method>

Flammabilities were confirmed based on JIS D1201-1977 F-MVSS302, and the burning velocities (mm/minute) were measured. Samples heat-aged by setting the manufactured flame-retardant fabrics in an oven of 100° C. for 500 hours, and by performing a heating promotion examination were measured when measuring the burning velocity of the flame-retardant fabric after heat aging.

<Bending Resistance Evaluation Method for Fabric>

The moved length (mm) of a sample bar was calculated based on a bending resistance 45° cantilever method of JIS L 1096.

TABLE 1

| | | | Example 1 | Example 2 | Example 3 | Example 4 | Example 5 | Example 6 | Example 7 |
|---|---|---|---|---|---|---|---|---|---|
| Composition | Thermally expansive graphite | | 100 | 100 | 100 | 100 | 100 | 100 | 100 |
| of composite | (average particle diameter: 300 μm) | | | | | | | | |
| graphite | Coating | Phosphate ester | 6.7 | 6.7 | 6.7 | 6.7 | 6.7 | 6.7 | 6.7 |
| (part by mass) | layer | (molecular weight: 512) | | | | | | | |
| | | Anionic surface-active | 1.4 | 1.4 | 1.4 | 1.4 | 1.4 | 1.4 | 1.4 |
| | | agent | | | | | | | |

| Composition | Water | 80 | 80 | 80 | 80 | 80 | 80 | 80 |
|---|---|---|---|---|---|---|---|---|
| of emulsion | Acrylic resin | 40 | 30 | 40 | 30 | 30 | 40 | 40 |
| (part by mass) | Composite thermally expansive | 20 | 20 | 30 | 30 | 40 | 20 | 20 |
| | graphite (flame-retardant) | | | | | | | |
| | Calcium carbonate | 20 | 30 | 10 | 20 | 10 | 20 | 20 |
| Applying amount of emulsion(solid content)(g/m²) | | 80 | 80 | 80 | 80 | 80 | 60 | 100 |
| Adhering amount of composite thermally expansive | | 20 | 20 | 30 | 30 | 40 | 15 | 25 |
| graphite of back layer(g/m²) | | | | | | | | |
| Adhering amount of calcium carbonate in back | | 20 | 30 | 10 | 20 | 10 | 15 | 25 |
| layer(g/m²) | | | | | | | | |
| Foaming ratio of back layer (times) | | 3 | 3 | 3 | 3 | 3 | 3 | 3 |
| Evaluation | Initial burning velocity | 55 | 54 | 0 | 0 | 0 | 69 | 41 |
| | (mm/minute) | | | | | | | |
| | Burning velocity after heat aging | 54 | 51 | 57 | 0 | 0 | 72 | 39 |
| | (mm/minute) | | | | | | | |
| | Bending resistance (mm) | 60 | 60 | 60 | 65 | 65 | 60 | 65 |

TABLE 2

| | | | Example 8 | Example 9 | Example 10 | Example 11 | Example 12 | Example 13 |
|---|---|---|---|---|---|---|---|---|
| Composition | Thermally expansive graphite | | 100 | 100 | 100 | 100 | 100 | 100 |
| of composite | (average particle diameter: 300 μm) | | | | | | | |
| graphite (part | Coating | Phosphate ester | 6.7 | 6.7 | 6.7 | 6.7 | 6.7 | 6.7 |
| by mass) | layer | (molecular weight: 512) | | | | | | |
| | | Anionic surface-active | 1.4 | 1.4 | 1.4 | 1.4 | 1.4 | 1.4 |
| | | agent | | | | | | |

| Composition | Water | 80 | 80 | 80 | 80 | 80 | 80 |
|---|---|---|---|---|---|---|---|
| of emulsion | Acrylic resin | 40 | 40 | 40 | 40 | 40 | 40 |
| (part by | Composite thermally expansive | 20 | 20 | 20 | 20 | 20 | 20 |
| mass) | graphite (flame-retardant) | | | | | | |
| | Calcium carbonate | 20 | 20 | 20 | — | 10 | 10 |
| | Magnesium hydroxide | — | — | — | 20 | 10 | — |
| | Calcium hydroxide | — | — | — | — | — | 10 |
| Applying amount of emulsion(solid content)(g/m²) | | 80 | 80 | 80 | 80 | 80 | 80 |
| Adhering amount of composite thermally expansive | | 20 | 20 | 20 | 20 | 20 | 20 |
| graphite of back layer(g/m²) | | | | | | | |
| Adhering amount of calcium carbonate in back | | 20 | 20 | 20 | 20 | 20 | 10 |
| layer(g/m²) | | | | | | | |
| Foaming ratio of back layer (times) | | 2 | 5 | 10 | 3 | 3 | 3 |
| Evaluation | Initial burning velocity (mm/minute) | 62 | 0 | 0 | 55 | 50 | 60 |
| | Burning velocity after heat aging | 64 | 0 | 0 | 60 | 55 | 65 |
| | (mm/minute) | | | | | | |
| | Bending resistance (mm) | 65 | 57 | 54 | 60 | 60 | 60 |

TABLE 3

| | | | Compara- | | Compara- | | Compara- | | Compara- | |
|---|---|---|---|---|---|---|---|---|---|---|
| | | | tive | Comparative | tive | Comparative | tive | Comparative | tive | Comparative |
| | | | Example 1 | Example 2 | Example 3 | Example 4 | Example 5 | Example 6 | Example7 | Example 8 |
| Composition | Thermally expansive graphite | | 100 | 100 | 100 | 100 | 100 | 100 | 100 | 100 |
| of composite | (average particle diameter: | | | | | | | | | |
| graphite | 300 μm) | | | | | | | | | |
| (part by | Coating | Phosphate ester | 6.7 | 6.7 | 6.7 | 6.7 | 6.7 | 6.7 | 6.7 | 6.7 |
| mass) | layer | (molecular weight: | | | | | | | | |
| | | 512) | | | | | | | | |
| | | Anionic | 1.4 | 1.4 | 1.4 | 1.4 | 1.4 | 1.4 | 1.4 | 1.4 |
| | | surface-active | | | | | | | | |
| | | agent | | | | | | | | |

| Composition | Water | 80 | 80 | 80 | 80 | 80 | 80 | 80 | 80 |
|---|---|---|---|---|---|---|---|---|---|
| of emulsion | Acrylic resin | 40 | 40 | 40 | 40 | 40 | 40 | 40 | 40 |
| (part by | Composite thermally | 5 | 55 | 35 | 15 | 20 | 20 | 20 | 20 |
| mass) | expansive graphite | | | | | | | | |
| | (flame-retardant) | | | | | | | | |
| | Calcium carbonate | 35 | 15 | 5 | 55 | 20 | 20 | — | — |
| | Ammonium polyphosphate | — | — | — | — | — | — | 20 | — |
| | Calcium hydroxide | — | — | — | — | — | — | — | 20 |
| Applying amount of emulsion(solid content) | | 80 | 110 | 80 | 110 | 30 | 180 | 80 | 80 |
| (g/m²) | | | | | | | | | |
| Adhering amount of composite thermally | | 5 | 65 | 35 | 15 | 7.5 | 45 | 20 | 20 |
| expansive graphite of back layer(g/m²) | | | | | | | | | |
| Adhering amount of calcium carbonate in | | 35 | 15 | 5 | 65 | 7.5 | 45 | — | — |
| back layer(g/m²) | | | | | | | | | |
| Foaming ratio of back layer (times) | | 3 | 3 | 3 | 3 | 3 | 3 | 3 | 3 |
| Evaluation | Initial burning velocity | 130 | 0 | 0 | 85 | 115 | 0 | 0 | 90 |
| | (mm/minute) | | | | | | | | |
| | Burning velocity after heat | 127 | 0 | 100 | 82 | 110 | 0 | 100 | 105 |
| | aging | | | | | | | | |
| | (mm/minute) | | | | | | | | |
| | Bending resistance (mm) | 60 | 75 | 65 | 85 | 55 | 85 | 65 | 60 |

As will be clearly understood from Tables, the flame-retardant fabrics of Examples 1 to 13 of the present invention had sufficient initial flame retardancy and excellent flame retardancy in heat aging. The flame-retardant fabrics also had sufficient flexibility as the fabric.

On the other hand, in Comparative Example 1 in which the adhering amount of the composite thermally expansive graphite is less than the prescribed range of the present invention, sufficient flame-retardant performance was not obtained both at the first stage and after heat aging. In Comparative Example 2 in which the adhering amount of the composite thermally expansive graphite exceeds the prescribed range of the present invention, there was a problem that surface hue was slightly thickened and dirt was generated in rolling up. In Comparative Example 3 which the adhering amount of the calcium carbonate was less than the prescribed range of the present invention, the flame-retardant performance in heat aging was inferior. There was a problem that the aesthetic property of the fabric was reduced in Comparative Example 4 in which the adhering amount of the calcium carbonate exceeds the prescribed range of the present invention. The flame-retardant performance in heat aging was inferior in Comparative Example 7 using the ammonium polyphosphate with the composite thermally expansive graphite.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A flame-retardant fabric comprising:
a fiber fabric; and
a back layer formed on a back surface of the fiber fabric and containing at least one of inorganic compound selected from the group consisting of calcium carbonate and magnesium hydroxide, thermally expansive graphite and a polymer substance,
wherein an adhering amount of solid of the back layer is 50 to 150 g/m²;
an adhering amount of the thermally expansive graphite is 15 to 60 g/m²; and
an adhering amount of the inorganic compound is 10 to 60 g/m².

2. The flame-retardant fabric as recited in claim 1, wherein at least a part of a surface of the thermally expansive graphite is coated by a phosphate ester and a surface-active agent.

3. The flame-retardant fabric as recited in claim 1, wherein at least a part of a surface of the thermally expansive graphite is coated by a surface-active agent layer intervening a phosphate ester layer.

4. The flame-retardant fabric as recited in claim 3, wherein a coating amount of phosphate ester is 5 to 50 parts by weight, and a coating amount of the surface-active agent is 0.5 to 10 parts by weight based on the thermally expansive graphite of 100 parts by weight.

5. The flame-retardant fabric as recited in claim 3, wherein a molecular weight of the phosphate ester is 400 to 1500.

6. The flame-retardant fabric as recited in claims 3, wherein the surface-active agent is an anionic surface-active agent.

7. The flame-retardant fabric as recited in claim 1, wherein the adhering amount of the thermally expansive graphite/the adhering amount of the inorganic compound is within the range of 0.3 to 3.

8. The flame-retardant fabric as recited in claim 1, wherein the adhering amount of the thermally expansive graphite/the adhering amount of the inorganic compound is within the range of 0.5 to 2.

9. The flame-retardant fabric as recited in claim 1, wherein the back layer has a foaming structure, and a foaming ratio is 1.1 to 15 times.

10. The flame-retardant fabric as recited in claim 1, wherein the back layer has a foaming structure, and a foaming ratio is 2 to 4 times.

11. The flame-retardant fabric as recited in claim 1, wherein an average particle diameter of the inorganic compound is 1 to 50 μm.

12. The flame-retardant fabric as recited in claim 1, wherein an average particle diameter of the thermally expansive graphite is 50 to 1000 μm.

13. The flame-retardant fabric as recited in claim 1, wherein an average particle diameter of the thermally expansive graphite is 120 to 330 μm.

14. The flame-retardant fabric as recited in claim 1, wherein the flame-retardant fabric is used as a vehicular interior material.

15. A vehicular interior material comprising:
a fiber fabric; and
a back layer formed on a back surface of the fiber fabric and containing at least one of inorganic compound selected from the group consisting of calcium carbonate and magnesium hydroxide, thermally expansive graphite and a polymer substance,
wherein an adhering amount of solid of the back layer is 50 to 150 g/m²;
an adhering amount of the thermally expansive graphite is 15 to 60 g/m²; and
an adhering amount of the inorganic compound is 10 to 60 g/m²,
the adhering amount of the thermally expansive graphite/the adhering amount of the inorganic compound is within the range of 0.3 to 3;
the back layer has a foaming structure, and a foaming ratio is 1.1 to 15 times;
an average particle diameter of the inorganic compound is 1 to 50 μm; and
an average particle diameter of the thermally expansive graphite is 50 to 1000 μm.

16. A method for manufacturing a flame-retardant fabric, comprising a step of applying a water-based polymer emulsion onto a back surface of a fiber fabric and drying it,
wherein the water-based polymer emulsion contains 80 to 200 parts by mass of a filler component based on 100 parts by mass of a polymer substance, and the filler component comprises at least one of inorganic compound selected from the group consisting of calcium carbonate and magnesium hydroxide, and thermally expansive graphite,
a ratio of a content of the thermally expansive graphite/a content of the inorganic compound is set to be 0.3 to 3, and
an amount of applied solid is set to be within a range of 50 to 150 g/m².

17. The flame-retardant fabric as recited in claim 2, wherein a coating amount of phosphate ester is 5 to 50 parts by weight, and a coating amount of the surface-active agent is 0.5 to 10 parts by weight based on the thermally expansive graphite of 100 parts by weight.

18. The flame-retardant fabric as recited in claim 2, wherein a molecular weight of the phosphate ester is 400 to 1500.

19. The flame-retardant fabric as recited in claim 2, wherein the surface-active agent is an anionic surface-active agent.
